(19) United States
(12) Patent Application Publication
(10) Pub. No.: US 2025/0280972 A1
(43) Pub. Date: Sep. 11, 2025

(54) Smart Mirror

(71) Applicant: Shenzhen Wivitouch Technology Co., Ltd., Shenzhen (CN)

(72) Inventors: Yanzhong Deng, Shenzhen (CN); Xingxing Xiang, Shenzhen (CN)

(21) Appl. No.: 18/644,013

(22) Filed: Apr. 23, 2024

(30) Foreign Application Priority Data
Mar. 8, 2024 (CN) 2024204766201

(51) Int. Cl. A47G 1/02; A47G 1/16; A47G 1/24; B41J 3/44; G03B 29/00

(52) U.S. Cl. CPC A47G 1/02; A47G 1/24; B41J 3/445; G03B 29/00; A47G 2001/1673; A47G 2200/143

(57) ABSTRACT

A smart mirror, including: mirror, divided into capturing part and displaying part, the capturing part be a pure mirror with a capturing hole configured in the middle to let the light unidirectionally pass through, the displaying part including displaying and touching pad; microcomputer, electrically connected with the displaying and touching pad on the mirror, camera, electrically connected with the microcomputer.

### FIELD OF THE INVENTION

This utility relates to intelligent interactive devices, and especially a smart mirror.

### BACKGROUND ART

Shooting is an inseparable part of our every daily life, and we tends to demand the growing entertainment property of shooting, and with the techniques more and more intelligent, video playing is one of the function that realizes.

In the current products, usually users input single capturing or playing instruction, instead of use more operations provided to do more entertainment. That's to say, current products is not so recreational with less functions, for example, provided with capturing with multiple angle, having many limitations.

### SUMMARY OF THE INVENTION

In order to satisfy the users' growing need, and realize more recreational interactive functions, the utility is provided with a smart mirror, including: mirror, divided into capturing part and displaying part, the capturing part be a pure mirror with a capturing hole configured in the middle to let the light unidirectionally pass through, the displaying part including displaying and touching pad; microcomputer, electrically connected with the displaying and touching pad; camera, electrically connected with the microcomputer.

In one form, the smart mirror also includes printing device, electrically connected with the microcomputer.

In one form, the surrounding of the mirror is configured with ambience lights.

In one form, the ambience lights are tunable light sources.

In one form, the smart mirror is configured to supporting shelves, to make the smart mirror set with the plane at certain angle.

In one form, the top of the supporting shelves is configured with add-on lights.

In one form, the add-on lights connect to the mirror, and the connecting point is set with adjustable components.

In one form, the printing device is a thermal printer.

In one form, the camera is a binocular camera.

In one form, the mirror also includes a speaker, electrically connected with the microcomputer.

The utility has the benefits of providing users with more recreational functions, to enable the operations of both capturing and video playing or other interactions with the computer.

### BRIEF DESCRIPTION OF THE DRAWINGS

FIG. 1 is a perspective view of one exemplary form of the smart mirror;

FIG. 2 is a rear view of one exemplary form of the smart mirror;

FIG. 3 is a side view of one exemplary form of the smart mirror;

FIG. 4 is a front view of one exemplary form of the smart mirror.

### DETAILED DESCRIPTION OF THE INVENTION

In order to make the above-mentioned purposes, features and advantages of the present invention more obvious and easy to understand, the present utility model will be further described in detail below with reference to the accompanying drawings and specific embodiments.

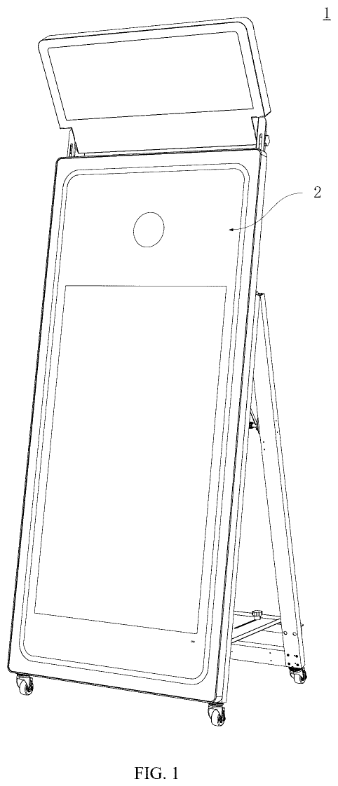

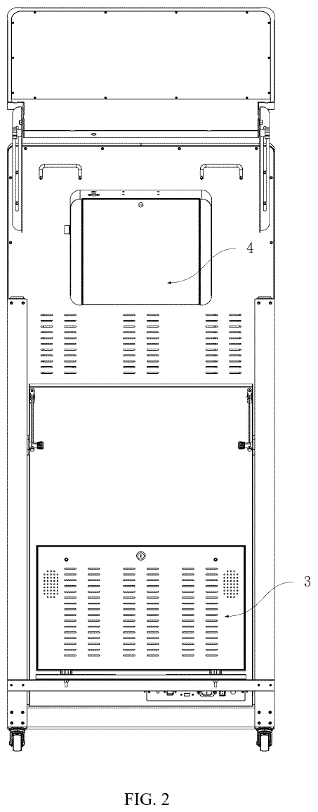

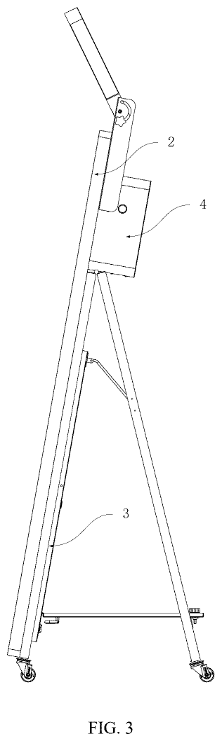

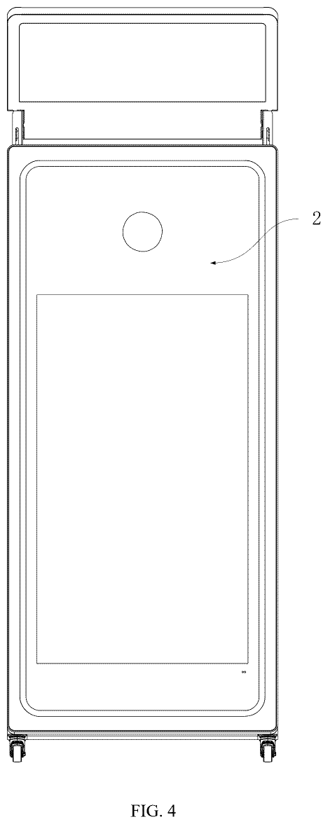

Referring to FIGS. 1 to 4, the smart mirror 1 of this embodiment includes: a mirror 2, a microcomputer 3, and a camera 4. The mirror 2 is divided into a capturing part and a displaying part. The capturing part is a pure mirror with a capturing hole configured in the middle to let the light unidirectionally pass through. The displaying part includes a displaying and touching pad, in which the microcomputer 3 is electrically connected to the displaying and touching pad on the mirror 2, and the camera 4 is electrically connected to the microcomputer 3.

The microcomputer 3 in this embodiment includes a motherboard, a CPU, a memory, a register, a communication interface, etc. The microcomputer 3 is electrically connected to peripheral devices related to the smart mirror, including the camera 4, printing equipment, speakers, etc., which are electrically connected to the microcomputer 3 respectively. The microcomputer 3 is used to process or store tasks or data related to taking pictures and playing videos. Smart mirrors are connected to communication interfaces, such as network cards, modems, wireless communication transceivers, etc. The communication unit allows the smart mirror to exchange information/data with other devices through computer networks such as the Internet and/or various telecommunications networks.

In this embodiment, the microcomputer 3 is arranged in the main box behind the mirror 2 and can realize any function that a personal computer can realize. For example, file browsing, user input, software program downloading, connecting to a local area network, etc. In this embodiment, the microcomputer 3 is provided with a wireless antenna, an RS454, RS232 or RJ45 wired interface, and a Bluetooth-related driver is also installed on the microcomputer 3.

The camera 4 in this embodiment may be a binocular camera, a monocular camera, a rangefinder camera, a single-lens reflex camera, a twin-lens reflex camera, a depth camera, a panoramic camera, etc. The specific selection can be made according to the actual situation, and this application does not specifically limit this. The camera 4 is electrically connected to the microcomputer 3, and the computer is equipped with software or program instructions for controlling the operation of the camera.

Mirror 2 is divided into a capturing part and a displaying part, and the capturing part and the displaying part are seamlessly connected.

In the smart mirror of this embodiment, a camera setting box is provided behind the capturing part. A camera 4 is placed in the camera setting box, and the camera 4 is electrically connected to the microcomputer 3. When the user inputs the camera function activation through the displaying and touching pad, the microcomputer 3 outputs an instruction to control the camera 4 to take pictures, and the camera 4 takes pictures through the capturing hole after receiving the instruction to take pictures. In some examples, the microcomputer 3 issues a continuous shooting instruction, and the camera 4 continuously takes N photos through the capturing hole, where N can be any integer greater than 0. In some examples, the number of N is user-defined. When the smart mirror of this embodiment is shooting, the capturing part still exhibits a mirror effect without being interfered by the capturing hole.

The displaying part includes a displaying and touching pad with mirror effect. There is a main box behind the displaying part, and a microcomputer 3 is placed in the main box. The microcomputer 3 is electrically connected to the displaying and touching pad. The user controls the microcomputer 3 through the displaying and touching pad, and the user selects to play the video. After receiving the input instruction from the user, the microcomputer 3 responds to the instruction and displays the corresponding interface and content on the displaying and touching pad. When playing a video, the mirror effect of the displaying part disappears, and the user can clearly watch the played content. When the video playback ends, and there is an end control input by the user or there is no user input for a long time, the displaying part enters the mirror effect.

In some examples, the displaying and touching pad may be an LCD (Liquid Crystal Display) screen, an OLED (Organic Light-Emitting Diode) screen, or an LED (Light Emitting Diode) screen. The specific selection can be made according to the actual situation, and this application does not specifically limit this.

The smart mirror in this embodiment is also provided with a sound sensor for sensing the music situation around the mirror. When there is no music playing around the mirror, the flashing state of the ambient light is the state set by the remote control. The flashing state of the ambient light at this time is called the default state. When there is music playing around the mirror, the sound sensor detects the music and obtains information such as the frequency and tone of the music. Based on this information, adaptive adjustments are made to the flashing of the ambient light, such as adjusting the flashing frequency and color of the ambient light, the length of each color segment, etc.

The smart mirror provided in this embodiment can print photos. When the user selects the photo taking function by displaying the touch screen, the camera 4 receives instructions and starts shooting through the capturing hole to obtain photos. The photos are processed and transmitted by the microcomputer 3 and sent to the printing device, and then printed After receiving the photos taken in real time, the device automatically develops and prints out the current photos. In some examples, the printing device is a thermal printer. Thermal printers are low-cost, fast and quiet, making them suitable for real-time photo development.

It should be noted that the above functions are only illustrative, and other related modifications are also within the scope of the concept.

In some examples, the smart mirror is installed on a support frame, and the support frame allows the smart mirror to be placed at a preset angle with a flat surface. The preset angle can be any angle greater than 0 or less than 180 degrees. In some other examples, pulleys are provided underneath the support frame. In this way, the mirror 2 can slide through the pulley when moving in a plane, which facilitates the movement of the smart mirror.

In some examples, the fill light is connected to the smart mirror, and the connection point is provided with a limited component. The function of the limit component is to fix the angle between the fill light and the smart mirror.

In some embodiments, the user inputs continuous shooting control instructions. After receiving the continuous shooting control instruction, the microcomputer 3 sends a countdown display instruction to the displaying and touching pad, and the displaying and touching pad displays a countdown to prompt the user to start shooting. The camera 4 continuously takes N photos through the capturing hole, where N can be any integer greater than 0. In some examples, the number of N is user-defined. In this embodiment, the number of N is 5 by default.

In other embodiments, the user controls the ambient light of the mirror 2 through a specific infrared remote control. The lighting effect of the ambient light can be monochromatic light, or several colors of light arranged and connected in a certain order. Since different lighting effects illuminate the object or human body in front of the mirror, the shooting effect is different, and the user in front of the mirror can understand the shooting effect brought by the current lighting effect based on the image reflected by the mirror, so the lighting effect can be adjusted accordingly. What users expect.

In some examples, a fill light is provided on the upper end of the support frame of the smart mirror. The angle between the fill light and the plane where the smart mirror is located is adjustable. The fill light and ambient light work together to achieve better shooting results. In some embodiments, the user controls the video stored on the microcomputer 3 through the touch screen, finds the stored video, and selects to play it. The video is played on the displaying part on the mirror 2. At the same time, if the video has sound, the speaker plays the sound. In this case, people watch the video in the posture of looking in the mirror, with a wide field of view and a better viewing experience.

In other embodiments, the smart mirror is placed in an environment where music is played. At this time, the sound sensor on the smart mirror can sense music-related information, such as the frequency of the music, the rhythm of the music, the tone of the music and its changes, etc., and adjust the flashing of the ambient light through the processing and calculation of the microcomputer 3 based on this information, such as adjusting the frequency of flashing, the color of the ambient light, the length of each color light, etc.

Various implementations of the systems and techniques described above may be implemented in digital electronic circuit systems, integrated circuit systems, field programmable gate arrays (FPGAs), application specific integrated circuits (ASICs), application specific standard products (ASSPs), systems on a chip implemented in a system (SOC), load programmable logic device (CPLD), computer hardware, firmware, software, and/or a combination thereof. These various embodiments may include implementation in one or more computer programs executable and/or interpreted on a programmable system including at least one programmable processor, the programmable processor The processor, which may be a special purpose or general purpose programmable processor, may receive data and instructions from a storage system, at least one input device, and at least one output device, and transmit data and instructions to the storage system, the at least one input device, and the at least one output device. An output device.

In this utility model, unless otherwise expressly stipulated and limited, the terms “installation”, “connection”, “connection”, “fixing” and other terms should be understood in a broad sense. For example, it can be a fixed connection or a detachable connection. Connection, or integration; it can be a mechanical connection or an electrical connection; it can be a direct connection or an indirect connection through an intermediary; it can be an internal connection between two elements or an interaction between two elements. For those of ordinary skill in the art, the specific meanings of the above terms in the present invention can be understood according to specific circumstances.

In the description of this specification, reference to the terms “one embodiment,” “some embodiments,” “examples,” “specific examples,” or “some examples” or the like means that specific features are described in connection with the embodiment or example, Structures, materials or features are included in at least one embodiment or example of the invention. In this specification, the schematic expressions of the above terms are not necessarily directed to the same embodiment or example. Furthermore, the specific features, structures, materials or characteristics described may be combined in any suitable manner in any one or more embodiments or examples. Furthermore, those skilled in the art may combine and combine different embodiments or examples and features of different embodiments or examples described in this specification unless they are inconsistent with each other.

The smart mirror provided by the present utility model has been introduced in detail above. Specific examples are used in this article to illustrate the principles and implementation methods of the utility model. The description of the above embodiments is only used to help understand the method of the utility model. and its core idea; at the same time, for those of ordinary skill in the field, there will be changes in the specific implementation and application scope according to the idea of the present utility model. In summary, the content of this specification should not be understood as an infringement of the present utility model.

1. A smart mirror, characterized by, including:
a mirror, divided into capturing part and displaying part, the capturing part be a pure mirror with a capturing hole configured in the middle to let the light unidirectionally pass through, the displaying part including displaying and touching pad;
microcomputer, electrically connected with the displaying and touching pad;
camera, electrically connected with a microcomputer.

2. The smart mirror according to claim 1, wherein the smart mirror also includes printing device, electrically connected with the microcomputer.

3. The smart mirror according to claim 1, wherein the surrounding of the mirror is configured with ambience lights.

4. The smart mirror according to claim 3, wherein the ambience lights are tunable light sources.

5. The smart mirror according to claim 1, wherein the smart mirror is configured to supporting shelves, to make the smart mirror set with the plane at certain angle.

6. The smart mirror according to claim 5, wherein the top of the supporting shelves is configured with add-on lights.

7. The smart mirror according to claim 6, wherein the add-on lights connect to the mirror, and the connecting point is set with adjustable components.

8. The smart mirror according to claim 2, wherein the printing device is a thermal printer.

9. The smart mirror according to claim 1, wherein the camera is a binocular camera.

10. The smart mirror according to claim 1, wherein the mirror also includes a speaker, electrically connected with the microcomputer.
